(19) United States
(12) Patent Application Publication
(10) Pub. No.: US 2003/0047550 A1
(43) Pub. Date: Mar. 13, 2003

(54) Continuous process for making electric blankets and pads with ptc wire

(76) Inventors: Leonard I. Horey, Boca Raton, FL (US); Armando Alvite, Miami, FL (US)

Correspondence Address: Lawrence J. Shurupoff, Sunbeam Products, Inc., 2381 Executive Center Drive, Boca Raton, FL, 33431, US

(21) Appl. No.: 10/244,158

(22) Filed: Sep. 10, 2002

Related U.S. Application Data
(60) Provisional application No. 60/318,998, filed on Sep. 11, 2001.
(60) Provisional application No. 60/318,986, filed on Sep. 11, 2001.
(60) Provisional application No. 60/318,917, filed on Sep. 11, 2001.

(51) Int. Cl. H05B 3/34

(52) U.S. Cl. 219/212; 219/529

(57) ABSTRACT

A heating blanket, pad or pillow is produced from a continuous roll of substrate material over which a continuous length of resistance heating wire is arranged. Predetermined lengths of the resulting substrate and heating element are cut from the roll to produce individual heating products. PTC wire is preferably used for the resistance wire and facilitates a continuous manufacturing process.

This application claims the benefit of U.S. Provisional Application Serial No. 60/318,998 filed Sep. 11, 2001, and Provisional Application Serial No. 60/318,986 filed Sep. 11, 2001, and Provisional Application Serial No. 60/318,917 filed Sep. 11, 2001.

### FIELD OF THE INVENTION

The present invention relates in general to heating blankets, pads, pillows, wraps and the like and in particular to a continuous process for forming a sheet of material having a heating wire attached in a serpentine pattern.

### DESCRIPTION OF PRIOR DEVELOPMENTS

Present day warming blankets are manufactured by an individual assembly process. Each blanket shell is individually wired. This requires application of significant time and labor to the manufacturing process. It would be desirable to change this manufacturing from an individual assembly process to more of a continuous process. However, the present electrical fault detecting safety circuits require the beginning and the end of the resistance heating wire to be terminated in a common blanket module or connector which is typically located at the point where the resistance wire or power cord enters the blanket shell. As a result, the end of the heating resistance wire must loop back to its beginning point where it enters the blanket to connect with the blanket module and safety circuit. This makes it difficult to manufacture the blankets with any type of continuous roll assembly process.

Even blankets using PTC heating elements typically include some form of connector and active circuit at the end of the PTC resistance wire, and then have one or more signal wires return to the safety circuit module. The presence of this active circuit forms an undesirable lump in the blanket. If the safety circuit were changed to an external current sensing circuit which monitored blanket current to check for faults, then there would be no need to loop the end of the blanket wire back to the beginning or entry point of the power cord. There would then be no need for mounting any electronics in the blanket.

By using current sensing to detect wire faults, the beginning of the resistance heating wire can be attached to an electrical connector and the end of the wire can simply be cut and terminated to prevent the ends of the wire from shorting together. This type of wiring assembly lends itself nicely to a continuous manufacturing process.

### SUMMARY OF THE INVENTION

In the continuous manufacturing process according to the invention, a thin substrate of, for example, non-woven synthetic gauze-like material is used to hold the wire in place in a predetermined pattern. The substrate material is fed from a large roll and the heating wire is attached to the substrate in a continuous serpentine pattern. After a sufficient length of wire is attached to the substrate, the wire and the first blanket length of substrate are cut from the roll and the next substrate begins to be wired. The far end of the heating wire in the first substrate is preferably capped or terminated to prevent shorting. The first substrate is then inserted into a blanket shell.

Connecting the beginning of the heating wire to the blanket connector completes the wiring process. In the event PTC wire is used for the heating element, the far free end of the wire can be located at the opposite end of the substrate or blanket from which it initially enters the blanket.

### BRIEF DESCRIPTION OF THE DRAWINGS

FIG. 1 is a schematic view of a pair of electrical heating blankets constructed individually in a batch type assembly process according to the prior art.

FIG. 2 is a schematic view of a pair of electric heating blanket substrates constructed in a continuous process in accordance with the present invention.

### DETAILED DESCRIPTION OF THE PREFERRED EMBODIMENTS

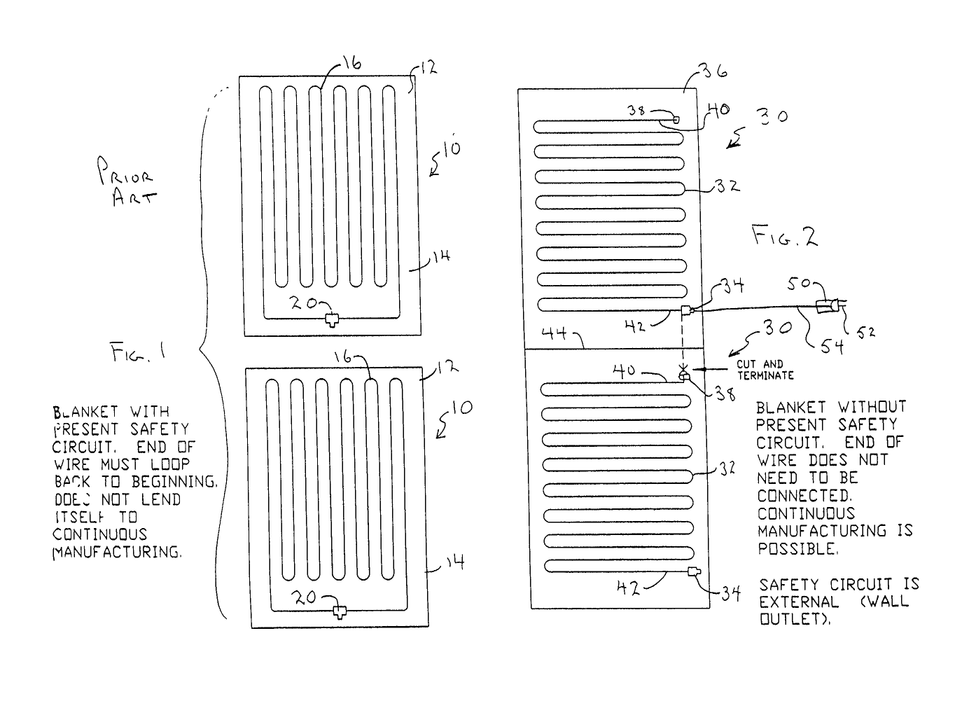

The present invention can be better appreciated from a review of the prior art heating blanket assemblies 10 shown in FIG. 1. The heating blanket assemblies 10 include a conventional fabric shell 12 which has an upper layer of fabric (not shown) and a lower layer of fabric 14 which form a pocket within which conventional resistance heating wire 16 is arranged in a serpentine pattern.

The serpentine wire pattern is typically arranged transversely, i.e., from left to right and right to left across the shell 12 with respect to the major dimension or length of the shell. The resistance heating wire 16 loops back to a connector 20 which connects to a power cord in a known fashion. The connector 20 typically includes safety circuitry or a safety circuit module. In this case, the resistance wire 16 must form a closed loop around and into connector 20 from the point where the wire enters the blanket. This requires individual assembly of each blanket assembly 10.

In contrast with the individual or “batch” process heating blanket manufacture shown in FIG. 1, a continuous manufacturing process can be used with the heating blanket assemblies 30 shown in FIG. 2. In this process, the resistance heating wire 32 is preferably positive temperature coefficient (PTC) heating wire.

By using current sensing, the wire need not loop back to electrical connector 34 as in the prior art assemblies of FIG. 1. Rather, the PTC wire 32 is arranged in a longitudinally-extending serpentine pattern along the length of a substrate sheet or web 36. This reduces the complexity of manufacture since the PTC wire can be fed continuously over the underlying substrate 36 in a back and forth pattern as the substrate moves continuously below the wire feeding apparatus.

Once a desired length of PTC wire is laid upon the substrate 36 in a desired pattern, the wire may be cut and terminated with a small safety connector or cap 38, leaving a free end 40 of PTC wire on the opposite end of the substrate from which the PTC wire was first applied.

A small electrical connector 34 is connected to the other free end 42 of the PTC wire 32 to connect the wire to a power cord. The cap 38 and simple connector 34 can be applied as the substrate is moving or during a dwell in its movement.

A cutter severs individual blanket assemblies 30 from a continuous roll of substrate material, which can be conventional fabric blanket material or a separate substrate material such as a non-woven light gauze-like material. The blanket assemblies 30 can be severed along partition lines 44 as the substrate is moving or during a brief dwell in its movement. The PTC wire can be secured to the substrate 36 with adhesive, with ultrasonic welds or by any other suitable means such as, for example, sewing.

If the substrate 36 is formed of a blanket fabric, a top layer of blanket fabric is subsequently applied over the illustrated bottom substrate layer in a known fashion after an individual assembly 30 is severed from the continuous substrate roll, and the connectors 38, 42 are connected to the PTC wire 32. If the substrate 36 is formed of a non-woven material or any other light breathable material, the entire assembly 30 may be later inserted within a conventional blanket shell. This approach allows a large inventory of heating blanket assemblies to serve as subassemblies which may later be inserted within any one of a number of different blanket shells formed of different blanket materials, colors and sizes.

The ability to locate a safety circuit module 50 externally of the blanket assembly 30 such as on the wall plug 52 of the power cord 54 which connects to the blanket assembly via connector 34 facilitates the continuous assembly process described above.

What is claimed is:

1. An electric heating assembly, comprising:
a pliable substrate; and
a resistance heating element arranged on said substrate, said resistance heating element having a first end portion receiving electrical power and a second free end portion spaced apart from said first end portion.

2. The assembly of claim 1, further comprising a first electrical connector connected to said first end portion and a second electrical connector connected to said second end portion.

3. The assembly of claim 1, wherein said resistance heating element is arranged in a serpentine pattern and wherein said substrate comprises a non-woven material.

4. The assembly of claim 1, wherein said substrate comprises a fabric blanket shell.

5. The assembly of claim 1, further comprising a blanket shell and wherein said substrate is disposed within said blanket shell.

6. The assembly of claim 1, further comprising a safety circuit located externally of and spaced apart from said substrate and adapted to control electrical current to said resistance heating element.

7. The assembly of claim 1, wherein said substrate comprises first and second spaced apart opposite end portions, wherein said resistance heating element extends longitudinally over said substrate, and wherein said first end portion of said resistance heating element is located adjacent said first end portion of said substrate and said second free end portion is located adjacent said second opposite end portion of said substrate.

8. A method of manufacturing a heating assembly, comprising:
longitudinally moving a continuous sheet of pliable substrate material along a path;
applying a length of resistance heating wire to said moving sheet of substrate material;
severing predetermined lengths of said substrate material from said sheet of substrate material; and
severing said resistance wire adjacent opposite longitudinal end portions of said predetermined lengths.

9. The method of claim 8, further comprising electrically connecting a safety circuit module to one end of said resistance heating wire at a location spaced apart from said severed predetermined lengths of said substrate.

10. The method of claim 9, further comprising placing a connector on the opposite end of said resistance heating wire.
